(19) United States
(12) Patent Application Publication
(10) Pub. No.: US 2015/0056491 A1
(43) Pub. Date: Feb. 26, 2015

(54) ORGANIC/INORGANIC COMPOSITE POROUS SEPARATOR AND PREPARATION METHOD THEREOF AND ELECTROCHEMICAL DEVICE

(71) Applicants: Dongguan Amperex Technology Limited, Dongguan (CN); Ningde Amperex Technology Limited, Ningde (CN)

(72) Inventors: Junhua ZHAO, Dongguan (CN); Shengwu Zhang, Dongguan (CN); Fenmin Cai, Dongguan (CN); Shenglong Wang, Dongguan (CN); Baiqing Zhang, Dongguan (CN)

(21) Appl. No.: 14/446,236

(22) Filed: Jul. 29, 2014

(30) Foreign Application Priority Data
Aug. 21, 2013 (CN) 201310368616.X

(51) Int. Cl. H01M 2/16; H01M 10/0525; H01M 2/14

(52) U.S. Cl. CPC H01M 2/166; H01M 2/145; H01M 2/1686; H01M 10/0525
USPC 429/144; 427/58

(57) ABSTRACT

The present disclosure provides an organic/inorganic composite porous separator and a preparation method thereof and an electrochemical device. The organic/inorganic composite porous separator comprises: a porous substrate; and an organic/inorganic composite porous coating coated on at least one surface of the porous substrate; the organic/inorganic composite porous coating comprises inorganic particles, an adhesive and organic particles with at least two swelling degrees, and the organic particles are swollen by a plasticizer. A preparation method of an organic/inorganic composite porous separator is used for preparing the previous organic/inorganic composite porous separator. An electrochemical device comprises the organic/inorganic composite porous separator. The separator can form an excellent interface, thereby reducing the risk of organic particles blocking micro pores, helping to improve the permeability of the separator, and improving the conductivity of the separator.

### CROSS-REFERENCE TO RELATED APPLICATIONS

The present application claims priority to Chinese patent application No. 201310368616.X, filed on Aug. 21, 2013, which is incorporated herein by reference in its entirety.

### FIELD OF THE PRESENT DISCLOSURE

The present disclosure relates to an electrochemistry technical field, and more specifically to an organic/inorganic composite porous separator and a preparation method thereof and an electrochemical device.

### BACKGROUND OF THE PRESENT DISCLOSURE

In order to solve safety problems, such as internal short circuit, that exist in an electrochemical device (such as a lithium-ion secondary battery), which traditionally uses a polyolefin porous substrate as a separator, many patent documents disclose an organic/inorganic composite porous separator which is composed of an porous substrate, inorganic particles and adhesive polymers.

Chinese patent application publication No. CN102610773A, published on Jul. 25, 2012, discloses a polymer lithium-ion battery and a separator thereof, the separator comprises a porous substrate, an inorganic coating and an organic coating. The organic coating is distributed in an island pattern and/or a linear pattern, and is coated on a surface of the porous substrate and/or a surface of the inorganic coating. However in the technical solution of this patent document, an organic solvent, such as NMP, ethanol and the like, is used in the coating during coating process, and it needs performing a multiple-time coating process.

Chinese patent application publication No. CN101542777A, published on Sep. 23, 2009, discloses an organic/inorganic composite separator having a porous active coating and an electrochemical device comprising the separator, the composite separator is formed by coating a mixture of inorganic particles and an adhesive polymer on a porous substrate, the adhesive polymer uses a mixture of two kinds of adhesive polymers whose contact angles with water droplets are different, in order to control the hydrophilicity of the polymer mixture; Chinese patent application publication No. CN101861667A, published on Oct. 13, 2010, discloses a separator having a porous coating and an electrochemical device comprising the separator, a copolymer of a first monomer unit and a second monomer unit is used, a water contact angle of the first monomer unit is 0˜49°, a water contact angle of the second monomer unit is 50˜130°, in order to improve the synergistic effect of the thermal stability of the organic/inorganic composite separator. Although the above two patent documents both use a one-time coating process and can use water as a solvent, they both need carefully to select ranges of water contact angles of the polymers or the monomer units, otherwise the obtained separator's performances may be seriously affected.

### SUMMARY OF THE PRESENT DISCLOSURE

In view of the problems existing in the background technology, an object of the present disclosure is to provide an organic/inorganic composite porous separator and a preparation method thereof and an electrochemical device, in which the organic/inorganic composite porous separator can be prepared with simple preparation processes and has good performances.

In order to achieve the above-mentioned object, in a first aspect of the present disclosure, the present disclosure provides an organic/inorganic composite porous separator, which comprises a porous substrate; and an organic/inorganic composite porous coating coated on at least one surface of the porous substrate; the organic/inorganic composite porous coating comprises inorganic particles, an adhesive and organic particles with at least two swelling degrees, and the organic particles are swollen by a plasticizer.

In the organic/inorganic composite porous separator according to the first aspect of the present disclosure, the organic/inorganic composite porous coating may be an island-planar shape, the island-planar shape comprises interconnected island regions and planar regions, taking an average swelling degree as a reference, the organic particles with the swelling degree not less than the average swelling degree are mainly distributed on a surface of the island regions, the inorganic particles and the organic particles with the swelling degree less than the average swelling degree are mainly distributed inside the island regions and on the planar regions.

In order to achieve the above-mentioned objects, in a second aspect of the present disclosure, the present disclosure provides a preparation method of an organic/inorganic composite porous separator for preparing the organic/inorganic composite porous separator according to the first aspect of the disclosure, which comprises steps of: dividing organic particles into at least two parts; adding the first part of the organic particles into a plasticizer and stirring together to swell the first part of the organic particles, then adding the second part of the organic particles and stirring to swell the second part of the organic particles, and so forth, so that the swelling degrees of organic particles vary from high to low according to adding orders; adding the obtained organic particles with at least two swelling degrees together with an adhesive into a solvent and mixing, after mixing evenly, adding inorganic particles and mixing evenly again, and obtaining an organic/inorganic composite slurry; coating the organic/inorganic composite slurry on at least one surface of a porous substrate, and then performing a drying process on the porous substrate with an organic/inorganic composite porous coating.

In the preparation method of an organic/inorganic composite porous separator according to the second aspect of the present disclosure, the solvent may be deionized water, and the porous substrate has a property that the porous substrate cannot be infiltrated with the deionized water.

In order to achieve the above-mentioned objects, in a third aspect of the present disclosure provides an electrochemical device comprising the organic/inorganic composite porous separator according to the first aspect of the present disclosure.

The beneficial effects of the present disclosure are as follows.

In the organic/inorganic composite porous separator according to the first aspect of the present disclosure, the organic/inorganic composite porous coating may allow the separator to form an excellent interface, thereby reducing the risk of organic particles blocking micro pores, helping to improve the permeability of the separator; the swollen organic particles can conduct ions, thereby improving the conductivity of the separator. The island-planar shaped organic/inorganic composite porous coating can make the permeability and conductivity of the organic/inorganic composite porous separator more excellent.

In the preparation method of an organic/inorganic composite porous separator according to the second aspect of the present disclosure, the interaction between the organic particles and the adhesive can be improved after making the organic particles pre-swell with different degrees, thereby not only improving stability of the slurry, but also improving interface performance between the organic/inorganic composite porous coating and the porous substrate/an electrode plate; furthermore, the separator according to the preparation method has a better permeability, conductivity, thermal stability, mechanical strength and oxidation resistance; and the separator according to the present disclosure can be made with a one-time coating, the process is simple, the condition is mild and is suitable for mass production. Moreover, preferably the deionized water is used as the solvent during the preparation process, and preferably the porous substrate has a property that the porous substrate cannot be infiltrated with deionized water. Since the deionized water and the porous substrate cannot be infiltrated with each other, the risk of blocking micro pores can be greatly reduced, and it is friendly to the environment and has a low cost.

In the electrochemical device according to the third aspect of the present disclosure, since it comprises the separator according to the first aspect of the present disclosure, which has a better permeability, conductivity, thermal stability, mechanical strength and oxidation resistance, the electrochemical performance of the electrochemical device comprising the separator can also be improved. Moreover, the island-planar shaped organic/inorganic composite porous coating can make the interface and an adhesion between the composite porous separator and the electrode plate excellent during following processes, thereby making the electrochemical device comprising the separator have an excellent mechanical performance; moreover, existence of the island regions provides spaces for expansion of the electrochemical device during cycling, so as to excellently solve deformation problem of the electrochemical device. So the electrochemical device comprising the separator has an anti-deformation capability, a better hardness and a better electrochemical performance.

### BRIEF DESCRIPTION OF THE FIGURES

FIG. 1 is a Scanning Electron Microscopy (SEM) picture of the organic/inorganic composite porous coating according to example 1 of the present disclosure, with a part of the island regions illustrated by circles.

### DETAILED DESCRIPTION

Hereinafter, an organic/inorganic composite porous separator and a preparation method thereof and an electrochemical device according to the present disclosure will be described in detail.

Firstly, an organic/inorganic composite porous separator according to a first aspect of the present disclosure will be described.

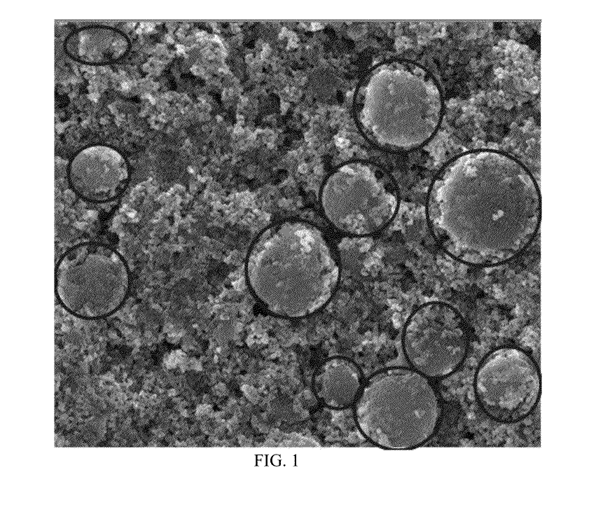

Referring to FIG. 1, an organic/inorganic composite porous separator according to the first aspect of the present disclosure comprises: a porous substrate; and an organic/inorganic composite porous coating coated on at least one surface of the porous substrate; the organic/inorganic composite porous coating comprises inorganic particles, an adhesive and organic particles with at least two swelling degrees, and the organic particles are swollen by a plasticizer. The organic/inorganic composite porous coating can make the separator form an excellent interface, thereby reducing the risk of organic particles blocking micro pores, helping to improve the permeability of the separator; the swollen organic particles can conduct ions, thereby improving the conductivity of the separator.

In the organic/inorganic composite porous separator according to the first aspect of the present disclosure, the organic/inorganic composite porous coating may be an island-planar shape, the island-planar shape comprises interconnected island regions and planar regions, taking an average swelling degree as a reference, the organic particles with the swelling degree not less than the average swelling degree are mainly distributed on a surface of the island regions, the inorganic particles and the organic particles with the swelling degree less than the average swelling degree are mainly distributed inside the island regions and on the planar regions. The island-planar shaped organic/inorganic composite porous coating can make the interface of the separator more excellent, and make the separator have a higher permeability; the inorganic particles distributed on the planar regions not only ensure the separator with an excellent mechanical performance, but also ensure the separator with a good thermal stability and oxidation resistance; the swollen organic particles can conduct ions, the organic particles with the swelling degree not less than the average swelling degree are mainly distributed on the surface of the island regions, and the organic particles with the swelling degree less than the average swelling degree are mainly distributed inside the island regions and on the planar regions, so that the ion-conducting ability between the inorganic particles can be improved, thereby making the separator with a better conductivity.

In the organic/inorganic composite porous separator according to the first aspect of the present disclosure, preferably, the porous substrate has a property that the porous substrate cannot be infiltrated with deionized water. The porous substrate may be selected from at least one of vinyl polymer and copolymer thereof, polyimide, polyamides, polyester, cellulose derivatives, and polysulfone. The vinyl polymer and copolymer thereof may be selected from at least one of polyethylene, polypropylene, polyethylene vinyl acetate copolymer, and polypropylene/polyethylene/polypropylene three-layer composite.

In the organic/inorganic composite porous separator according to the first aspect of the present disclosure, the organic particles may be selected from at least one of polyvinylidene fluoride, vinylidene fluoride-hexafluoropropylene copolymer, polyacrylonitrile, polyimide, acrylonitrile-butadiene copolymer, acrylonitrile-styrene-butadiene copolymer, polymethylmethacrylate, poly(methyl acrylate), poly(ethyl acrylate), acrylic acid-styrene copolymer, polydimethylsiloxane, sodium polyacrylate, and sodium carboxymethyl cellulose.

In the organic/inorganic composite porous separator according to the first aspect of the present disclosure, the inorganic particles may be selected from at least one of Al₂O₃, SiO₂, TiO₂, CeO₂, CaCO₃, CaO, ZnO, MgO, CeTiO₃, CaTiO₃, BaTiO₃, Li₃PO₄, LiTi₂(PO₄)₃, LiAlTi₂(PO₄)₄, Li₃N, and LiLa(TiO₃)₂. An average particle size of the inorganic particles may be 0.001 μm˜9 μm.

In the organic/inorganic composite porous separator according to the first aspect of the present disclosure, the adhesive may be selected from at least one of polyacrylic acid, poly(methacrylic acid), poly(methyl acrylate), poly(ethyl acrylate), pure acrylic emulsion, acrylic acid-styrene copolymer, polyvinyl pyrrolidone, styrene-butadiene rubber, epoxy resin, neopentyl glycol diacrylate, sodium polyacrylate and derivatives thereof, and PTFE.

In the organic/inorganic composite porous separator according to the first aspect of the present disclosure, the plasticizer may be selected from at least one of a true solvent, a transition state solvent, and a cosolvent. The true solvent may be selected from at least one of acetone, THF, MEKPO, DMF, DMAC, tetramethylurea, tetramethyl phosphate, and NMP. The transition state solvent is selected from at least one of isophorone, butyrolactone, and carbitol acetate. The cosolvent may be selected from at least one of methyl isobutyl ketone, n-butyl acetate, cyclohexanone, diacetone alcohol, diisobutyl ketone, ethyl acetoacetate, dibutyl phthalate, ethylene carbonate, propylene carbonate, and dimethyl carbonate.

In the organic/inorganic composite porous separator according to the first aspect of the present disclosure, the organic/inorganic composite porous separator comprises the organic particles with two swelling degrees, taking an average swelling degree as a reference, a mass ratio of the organic particles with the swelling degree not less than the average swelling degree to all the organic particles may be 5%˜60%.

In the organic/inorganic composite porous separator according to the first aspect of the present disclosure, taking a total mass of the plasticizer, the organic particles, the inorganic particles and the adhesive as a reference, a mass ratio of the plasticizer may be 0.2%˜45%, preferably 1%˜15%.

In the organic/inorganic composite porous separator according to the first aspect of the present disclosure, a thickness of the organic/inorganic composite porous coating may be 1 μmμ35 μm.

In the organic/inorganic composite porous separator according to the first aspect of the present disclosure, a mass ratio of the organic particles before swelling to the inorganic particles may be 10%˜90%, preferably 20%˜55%; a mass ratio of the adhesive to the sum of the organic particles before swelling and the inorganic particles can be 0.01%˜30%, preferably 1%˜15%.

In the organic/inorganic composite porous separator according to the first aspect of the present disclosure, an area ratio of the island regions to the planar regions in the organic/inorganic composite porous coating may be 0.1˜10, preferably 0.5˜5.

Secondly, a preparation method of an organic/inorganic composite porous separator according to a second aspect of the present disclosure will be described.

A preparation method of an organic/inorganic composite porous separator according to a second aspect of the present disclosure, for preparing the organic/inorganic composite porous separator according to the first aspect of the present disclosure, comprises steps of: dividing organic particles into at least two parts; adding the first part of the organic particles into a plasticizer and stirring together to swell the first part of the organic particles, then adding the second part of the organic particles and stirring to swell the second part of the organic particles, and so forth, so that the swelling degrees of the organic particles vary from high to low according to adding orders; adding the obtained organic particles with at least two swelling degrees together with an adhesive into a solvent and mixing, after mixing evenly, adding inorganic particles and mixing evenly again, and obtaining an organic/inorganic composite slurry; coating the organic/inorganic composite slurry on at least one surface of a porous substrate, and then performing a drying process on the porous substrate with an organic/inorganic composite porous coating. The interaction between the organic particles and the adhesive can be improved after pre-swelling the organic particles with different degrees, thereby not only improving the stability of the slurry, but also improving the interfacial characteristics between the organic/inorganic composite porous coating and the porous substrate/an electrode plate; furthermore, the separator according to the preparation method has a better permeability, conductivity, thermal stability, mechanical strength and oxidation resistance; and the separator according to the present disclosure can be made with a one-time coating, the process is simple, the condition is mild and is suitable for mass production. It should be noted that, the adding order of the above organic particles with at least two swelling degrees, the adhesive, and the inorganic particles into the solvent can be adjusted.

Furthermore, preferably the deionized water is used as the solvent in the preparation process, and preferably the porous substrate has a property that the porous substrate cannot be infiltrated with the deionized water. Since the deionized water and the porous substrate cannot be infiltrated with each other, the risk of the organic particles blocking micro pores can be greatly reduced, and it is friendly to the environment and has a low cost.

In the preparation method of the organic/inorganic composite porous separator according to the second aspect of the present disclosure, the organic particles is divided into two parts, and a mass ratio of the first part of the organic particles to all the organic particles may be 5%˜60%.

In the preparation method of the organic/inorganic composite porous separator according to the second aspect of the present disclosure, taking a total mass of the plasticizer, the organic particles, the inorganic particles, and the adhesive as a reference, a mass ratio of the plasticizer may be 0.2%˜45%, preferably 1%˜15%.

In the preparation method of the organic/inorganic composite porous separator according to the second aspect of the present disclosure, an ambient temperature of adding the each part of the organic particles into the plasticizer and stirring may be 20° C.˜55° C.

In the preparation method of the organic/inorganic composite porous separator according to the second aspect of the present disclosure, the stirring may be selected from at least one of mechanical stirring, ball milling and ultrasonic dispersion.

In the preparation method of the organic/inorganic composite porous separator according to the second aspect of the present disclosure, the solvent may be deionized water, and the porous substrate has a property that the porous substrate cannot be infiltrated with the deionized water. And an amount of deionized water is used so that a solid content of the organic/inorganic composite slurry may be 30%˜65%, preferably 35%˜55%. In the preparation method of the organic/inorganic composite porous separator according to the second aspect of the present disclosure, the solvent may be NMP, acetone, THF, dichloromethane, chloroform, DMF, cyclohexane and a mixture thereof, and a mixture thereof with deionized water.

In the preparation method of an organic/inorganic composite porous separator according to the second aspect of the present disclosure, the coating method may be selected from dip coating, gravure printing, screen printing, transfer coating, extrusion coating, spray coating, and cast coating. A coating speed may be 2 m/min˜40 m/min;

In the preparation method of the organic/inorganic composite porous separator according to the second aspect of the present disclosure, a temperature of the drying process may be 35° C.˜130° C.

In the preparation method of the organic/inorganic composite porous separator according to the second aspect of the present disclosure, a drying process may be performed within a multi-stage oven, a temperature of the oven is set that temperatures at a head stage and a tail stage are below a temperature of an intermediate stage.

Next an electrochemical device according to a third aspect of the present disclosure will be described.

An electrochemical device according to a third aspect of the present disclosure comprises the organic/inorganic composite porous separator according to the first aspect of the present disclosure.

In the electrochemical device according to the third aspect of the present disclosure may be a lithium secondary battery, a lithium-ion secondary battery, a super capacitor, a fuel cell, or a solar cell. The lithium-ion secondary battery may be a polymer lithium-ion secondary battery.

In the electrochemical device according to the third aspect of the present disclosure, since it uses the organic/inorganic composite porous separator according to the first aspect of the present disclosure, so it has the following effects:

(1) Since the separator according to the first aspect of the present disclosure has a better permeability, conductivity, thermal stability, mechanical strength and oxidation resistance, the electrochemical performance of the electrochemical device comprising the separator can also be improved;

(2) The island-planar shaped organic/inorganic composite porous coating can make the interface and an adhesion between the composite porous separator and an electrode plate excellent during following processes, thereby making the electrochemical device comprising the separator have an excellent mechanical performance;

(3) Moreover, existence of the island regions provides spaces for expansion of the electrochemical device during cycling, so as to excellently solve the deformation problem of the electrochemical device;

So the electrochemical device comprising the separator has an anti-deformation capability, a better hardness and a better electrochemical performance (such as cycle performance of a secondary battery when the electrochemical device is a secondary battery).

Hereinafter examples and comparative examples of the organic/inorganic composite porous separator and the preparation method thereof and the electrochemical device according to the present disclosure will be described.

### COMPARATIVE EXAMPLE

Positive electrode plate: lithium cobaltate, conductive carbon, poly-vinylidene fluoride as adhesive according to a mass ratio of 96:2.0:2.0 were uniformly mixed with N-methyl pyrrolidone (NMP) to form a positive electrode slurry, which was then coated on an aluminum foil, baking was then performed at 85° C., which was followed by cold pressing, cutting, edge-trimming, slitting, welding a tab, finally a positive electrode plate was obtained.

Negative electrode plate: graphite, conductive carbon, sodium carboxymethyl cellulose as thickening agent, styrene-butadiene rubber as adhesive according to a mass ratio of 96.5:1.0:1.0:1.5 were uniformly mixed with deionized water to form a negative electrode slurry, which was then coated on an copper foil, baking was then performed at 85° C., which was followed by cold pressing, cutting, edge-trimming, slitting, welding a tab, finally a negative electrode plate was obtained.

Separator: a thickness of 20 μm of a polypropylene/polyethylene/polypropylene three-layer composite micro porous separator was chosen as the separator.

Non-aqueous electrolyte: LiPF₆ and ethylene carbonate (EC) and diethyl carbonate (DEC) were used to form a solution with a LiPF₆ concentration of 1.0 mol/L (the mass ratio of EC:DEC was 3:7), a non-aqueous electrolyte was obtained.

Forming battery: the positive electrode plate, the separator, the negative electrode plate were wound together to form a cell, which was followed by placing the cell in an aluminum foil package bag and injecting the prepared electrolyte, then after processes of packing, formation, capacity testing and other processes, a battery was completed.

### EXAMPLE 1

Positive electrode plate, negative electrode plate, non-aqueous electrolyte and forming battery were the same as those in comparative example, except that the separator was prepared as follows:

0.06 parts by mass of ethylacetoacetate (plasticizer) and 0.14 parts by mass of poly-vinylidene fluoride (organic particles) powder were added into a double planetary stirrer, followed by a stirring at 55° C. for 30 min, then another 2.66 parts by mass of poly-vinylidene fluoride powder were added and stirred for 1 h; then 0.06 parts by mass of polymethylacrylate and 68.986 parts by mass of deionized water were added and mixed at 55° C. for 0.5 h; then 28 parts by mass of Al₂O₃ (the average particle size was 1 μm) were added and stirred for 2 h under room temperature, finally an organic/inorganic composite slurry was obtained.

Both surfaces of a polypropylene porous substrate were coated by transfer coating method and dried within a three-stage oven (the length of each stage was 3 m, the temperatures of three stages were 40° C., 42° C., 40° C., respectively), the coating speed was 40 m/min. The thickness of the coating after drying on a single surface was 8 μm.

### EXAMPLE 2

Positive electrode plate, negative electrode plate, non-aqueous electrolyte, forming battery were the same as those in comparative example, except that the separator was prepared as follows:

0.6 parts by mass of dimethyl carbonate (plasticizer) and 0.295 parts by mass of acrylonitrile-butadiene copolymer (organic particles) powder were added into a double planetary stirrer, followed by a stirring at 45° C. for 30 min, another 5.605 parts by mass of acrylonitrile-butadiene copolymer powder were added and stirred for 1 h; then 0.6 parts by mass of pure acrylic emulsion and 34.2 parts by mass of deionized water were added and mixed at 45° C. for 0.5 h; then 59 parts by mass of MgO (the average particle size was 5 μm) were added and stirred for 2 h under room temperature, finally an organic/inorganic composite slurry was obtained.

Both surfaces of a polypropylene/polyethylene/polypropylene three-layer composite porous substrate were coated by screen printing method, and dried within a three-stage oven (the length of each stage was 3 m, the temperatures of three stages were 120° C., 130° C., 120° C., respectively), the coating speed was 2 m/min. The thickness of the coating after drying on a single surface was 35 μm.

### EXAMPLE 3

Positive electrode plate, negative electrode plate, non-aqueous electrolyte, forming battery were the same as those in comparative example, except that the separator was prepared as follows:

22 parts by mass of dimethylformamide (DMF, plasticizer) and 11.7 parts by mass of polyacrylonitrile (organic particles) powder were added into a double planetary stirrer, followed by a stirring at 35° C. for 30 min, another 11.7 parts by mass of polyacrylonitrile powder were added and stirred for 1 h; then 14.82 parts by mass of neopentyl glycol diacrylate and 13.78 parts by mass of deionized water were added and mixed at 35° C. for 0.5 h; then 26 parts by mass of SiO₂ (the average particle size was 10 nm) were added and stirred for 2 h under room temperature, finally an organic/inorganic composite slurry was obtained.

Both surfaces of a polypropylene/polyethylene/polypropylene three-layer composite porous substrate were coated by extrusion coating method, and dried within a three-stage oven (the length of each stage was 3 m, the temperatures of three stages were 68° C., 70° C., 65° C., respectively), the coating speed was 15 m/min. The thickness of the coating after drying on a single surface was 10 μm.

### EXAMPLE 4

Positive electrode plate, negative electrode plate, non-aqueous electrolyte, forming battery were the same as those in comparative example, except that the separator was prepared as follows:

3 parts by mass of carbitol acetate (plasticizer) and 0.52 parts by mass of polyimide (organic particles) powder were added into a double planetary stirrer, followed by a stirring at 45° C. for 30 min, another 4.68 parts by mass of polyimide powder were added and stirred for 1 h; then 0.312 parts by mass of epoxy resin and 65.488 parts by mass of deionized water were added and mixed at 45° C. for 0.5 h; then 26 parts by mass of CeTiO₃ (the average particle size was 8 μm) were added and stirred for 2 h under room temperature, finally an organic/inorganic composite slurry was obtained.

Both surfaces of a polypropylene/polyethylene/polypropylene three-layer composite porous substrate were coated by dip coating, and dried within a three-stage oven (the length of each stage was 3 m, the temperatures of three stages were 50° C., 56° C., 52° C., respectively), the coating speed was 20 m/min. The thickness of the coating after drying on a single surface was 1 μm.

### EXAMPLE 5

Positive electrode plate, negative electrode plate, non-aqueous electrolyte, forming battery were the same as those in comparative example, except that the separator was prepared as follows:

5 parts by mass of ethylene carbonate (plasticizer) and 4.95 parts by mass of polymethylmethacrylate (organic particles) powder were added into a double planetary stirrer, followed by a stirring at 20° C. for 30 min, another 11.55 parts by mass of polymethylmethacrylate powder were added and stirred for 1 h; then 6.975 parts by mass of acrylic-styrene copolymer and 41.525 parts by mass of deionized water were added and mixed at 20° C. for 0.5 h; then 30 parts by mass of CaCO₃ (the average particle size was 2 μm) were added and stirred for 2 h under room temperature, finally an organic/inorganic composite slurry was obtained.

Both surfaces of a polyimide porous substrate were coated by spray coating, and dried within a three-stage oven (the length of each stage was 3 m, the temperatures of three stages were 46° C., 49° C., 45° C., respectively), the coating speed was 32 m/min. The thickness of the coating after drying on a single surface was 6 μm.

### EXAMPLE 6

Positive electrode plate, negative electrode plate, non-aqueous electrolyte, forming battery were the same as those in comparative example, except that the separator was prepared as follows:

23 parts by mass of ethylacetoacetate (plasticizer) and 5 parts by mass of sodium carboxymethyl cellulose (organic particles) powder were added into a double planetary stirrer, followed by a stirring at 55° C. for 30 min, another 4 parts by mass of sodium carboxymethyl cellulose powder were added and stirred for 1 h; then 6 parts by mass of styrene-butadiene rubber (SBR) and 29 parts by mass of N methylpyrrolidone (NMP) were added and mixed at 55° C. for 0.5 h; then 30 parts by mass of Li₃PO₄ (the average particle size was 5 nm) and were added stirred for 2 h under room temperature, finally an organic/inorganic composite slurry was obtained.

Both surfaces of a polypropylene/polyethylene/polypropylene three-layer composite porous substrate were coated by flow cast coating, and dried within a three-stage oven (the length of each stage was 3 m, the temperatures of three stage were 89° C., 92° C., 85° C., respectively), the coating speed was 17 m/min. The thickness of the coating after drying on a single surface was 10 μm.

Hereinafter testing processes and results concerning performances of separators and batteries (i.e. lithium-ion secondary batteries) according to comparative example and examples 1-6 were presented.

(1) Testing of planar-island area ratios of the separators: measuring the planar-island area ratios by SEM, wherein the planar-island area ratio was the ratio of the area of the planar regions to the area of the island regions.

(2) Testing of porosity of the separators: testing with a pressure mercury analyzer.

(3) Testing of permeability of the separators: testing with an air permeability tester.

(4) Testing of puncture strength of the separators: using a round nail with a diameter of 0.5 mm to puncture the separators at a speed of 50 mm/min.

(5) Testing of heat shrinkage ratios of the separators: punching the separators into square pieces with a die cutter, putting the square pieces into a thermostatic oven set at a certain temperature, then taking the square pieces out after a certain time, and testing the heat shrinkage ratios of the separators according to the separators before and after the heat processing.

(6) Testing of cycle performances of the lithium-ion secondary batteries: the lithium-ion secondary batteries were charged and discharged at a constant current rate of 0.5 C under room temperature, and successively were conducted for 500 cycles. The capacity retention ratios were calculated as follows:

Capacity retention ratio=(the capacity of the lithium-ion secondary battery after 500 cycles/the capacity of the lithium-ion secondary battery before cycling under room temperature)×100%.

(7) Testing of high-temperature storage performances of the lithium-ion secondary batteries: the lithium-ion secondary batteries with 100% SOC (4.2V) were stored under 80° C. for 30 days. The thickness expansion ratio was calculated as follows:

Thickness expansion ratio=(the difference in the thicknesses of the lithium-ion secondary battery before and after storing/the thickness of the lithium-ion secondary battery before storing)×100%.

Testing results concerning performances of the separators and the lithium-ion secondary batteries based on comparative example and examples 1-6 were shown in Table 1.

TABLE 1
Testing results concerning performances of the separators and the lithium-
ion secondary batteries based on comparative example and examples 1 -6

| | | | | | | Lithium-ion | |
|---|---|---|---|---|---|---|---|
| | Separator | | | | | secondary battery | |
| | | | | | Heat | Capacity | Thickness |
| | | | | Puncture | shrinkage | retention | Expansion |
| | planar-island | Porosity | Permeability | strength | ratio | ratio | ratio |
| | area ratio | (%) | (s/100 cc) | (Kgf) | (%) | (%) | (%) |
| Comparative example | — | 37 | 361 | 0.241 | 2.1 | 82.1 | 21.1 |
| Example 1 | 0.5 | 39 | 370 | 0.273 | 0.80 | 89.2 | 5.4 |
| Example 2 | 5 | 38 | 375 | 0.283 | 0.30 | 88.7 | 3.0 |
| Example 3 | 0.1 | 45 | 365 | 0.276 | 0.50 | 89.7 | 4.3 |
| Example 4 | 0.5 | 43 | 368 | 0.273 | 0.80 | 90.3 | 5.9 |
| Example 5 | 5 | 41 | 372 | 0.276 | 0.60 | 90.1 | 5.4 |
| Example 6 | 3 | 40 | 370 | 0.274 | 0.70 | 89.5 | 4.1 |

It may be seen from Table 1, an introduction of the organic/inorganic composite coating in examples 1-6 greatly improved the anti-puncture ability and thermal stability of the separator, and the organic/inorganic composite coating in examples 1-6 did not decrease the permeability of the separator due to blocking micro pores.

The organic/inorganic composite coatings in the lithium-ion secondary batteries in examples 1-6 greatly improved the adhesiveness between the electrode plates and thereby inhibiting the thermal expansion of the lithium-ion secondary batteries, the organic/inorganic composite coating not only improved the performances of the separator, but also improved cycling performances and high temperature storage performances of the lithium-ion secondary battery.

What is claimed is:

1. An organic/inorganic composite porous separator, comprising:
a porous substrate; and
an organic/inorganic composite porous coating coated on at least one surface of the porous substrate;
the organic/inorganic composite porous coating comprising inorganic particles, an adhesive and organic particles with at least two swelling degrees, and the organic particles being swollen by a plasticizer.

2. The organic/inorganic composite porous separator according to claim 1, wherein the organic/inorganic composite porous coating is an island-planar shape, the island-planar shape comprises interconnected island regions and planar regions, taking an average swelling degree as a reference, the organic particles with the swelling degree not less than the average swelling degree are mainly distributed on a surface of the island regions, the inorganic particles and the organic particles with the swelling degree less than the average swelling degree are mainly distributed inside the island regions and on the planar regions.

3. The organic/inorganic composite porous separator according to claim 1, wherein the porous substrate has a property that the porous substrate cannot be infiltrated with deionized water.

4. The organic/inorganic composite porous separator according to claim 1, wherein
the porous substrate is selected from at least one of vinyl polymer and copolymer thereof, polyimide, polyamides, polyester, cellulose derivative, and polysulfone;
the organic particles are selected from at least one of polyvinylidene fluoride, vinylidene fluoride-hexafluoropropylene copolymer, polyacrylonitrile, polyimide, acrylonitrile-butadiene copolymer, acrylonitrile-styrene-butadiene copolymer, polymethylmethacrylate, poly(methyl acrylate), poly(ethyl acrylate), acrylic acid-styrene copolymer, polydimethylsiloxane, sodium polyacrylate, and sodium carboxymethyl cellulose;
the inorganic particles are selected from at least one of Al₂O₃, SiO₂, TiO₂, CeO₂, CaCO₃, CaO, ZnO, MgO, CeTiO₃, CaTiO₃, BaTiO₃, Li₃PO₄, LiTi₂(PO₄)₃, LiAlTi₂(PO₄)₄, Li₃N, and LiLa(TiO₃)₂;
the adhesive is selected from at least one of polyacrylic acid, poly(methacrylic acid), poly(methyl acrylate), poly(ethyl acrylate), pure acrylic emulsion, acrylic acid-styrene copolymer, polyvinyl pyrrolidone, styrene-butadiene rubber, epoxy resin, neopentyl glycol diacrylate, sodium polyacrylate and derivatives thereof, and PTFE; and
the plasticizer is selected from at least one of a true solvent, a transition state solvent, and a cosolvent.

5. The organic/inorganic composite porous separator according to claim 1, wherein the organic/inorganic composite porous separator comprises the organic particles with two swelling degrees, taking an average swelling degree as a reference, a mass ratio of the organic particles with the swelling degree not less than the average swelling degree to all the organic particles is 5%˜60%.

6. The organic/inorganic composite porous separator according to claim 1, wherein taking a total mass of the plasticizer, the organic particles, the inorganic particles and the adhesive as a reference, a mass ratio of the plasticizer is 0.2%˜45%.

7. The organic/inorganic composite porous separator according to claim 6, wherein taking a total mass of the plasticizer, the organic particles, the inorganic particles and the adhesive as a reference, a mass ratio of the plasticizer is 1%˜15%.

8. The organic/inorganic composite porous separator according to claim 1, wherein an average particle size of the inorganic particles is 0.001 μm˜9 μm.

9. The organic/inorganic composite porous separator according to claim 1, wherein a thickness of the organic/inorganic composite porous coating is 1 μm˜35 μm.

10. The organic/inorganic composite porous separator according to claim 1, wherein
a mass ratio of the organic particles before swelling to the inorganic particles is 10%˜90%;
a mass ratio of the adhesive to the sum of the organic particles before swelling and the inorganic particles is 0.01%˜30%.

11. The organic/inorganic composite porous separator according to claim 2, wherein an area ratio of the island regions to the planar regions in the organic/inorganic composite porous coating is 0.1˜10.

12. The organic/inorganic composite porous separator according to claim 11, wherein the area ratio of the island regions to the planar regions in the organic/inorganic composite porous coating is 0.5˜5.

13. A preparation method of an organic/inorganic composite porous separator, comprising steps of:
dividing organic particles into at least two parts;
adding the first part of the organic particles into a plasticizer and stirring together to swell the first part of the organic particles, then adding the second part of the organic particles and stirring to swell the second part of the organic particles, and so forth, so that swelling degrees of the organic particles vary from high to low according to adding orders;
adding the obtained organic particles with at least two swelling degrees together with an adhesive into a solvent and mixing, after mixing evenly, adding inorganic particles and mixing evenly again, and obtaining an organic/inorganic composite slurry;
coating the organic/inorganic composite slurry on at least one surface of a porous substrate, and then performing a drying process on the porous substrate with an organic/inorganic composite porous coating.

14. The preparation method of the organic/inorganic composite porous separator according to claim 13, wherein the solvent is deionized water, and the porous substrate has a property that the porous substrate cannot be infiltrated with the deionized water.

15. The preparation method of the organic/inorganic composite porous separator according to claim 13, wherein dividing organic particles into two parts, and a mass ratio of the first part of the organic particles to all the organic particles is 5%˜60%.

16. The preparation method of the organic/inorganic composite porous separator according claim 14, wherein
taking a total mass of the plasticizer, the organic particles, the inorganic particles, the adhesive as a reference, a mass ratio of the plasticizer is 0.2%˜45%;
an amount of the deionized water is used so that a solid content of the organic/inorganic composite slurry is 30%˜65%.

17. The preparation method of the organic/inorganic composite porous separator according to claim 13, wherein
an ambient temperature of adding the each part of the organic particles into the plasticizer and stirring is 20° C.˜55° C.;
a coating speed is 2 m/min˜40 m/min;
a temperature of the drying process is 35° C.˜130° C.

18. An electrochemical device, comprising an organic/inorganic composite porous separator, the organic/inorganic composite porous separator comprising:
a porous substrate; and
an organic/inorganic composite porous coating coated on at least one surface of the porous substrate;
the organic/inorganic composite porous coating comprising inorganic particles, an adhesive and organic particles with at least two swelling degrees, and the organic particles being swollen by a plasticizer.

19. The electrochemical device according to claim 18, wherein the organic/inorganic composite porous coating is an island-planar shape, the island-planar shape comprises interconnected island regions and planar regions, taking an average swelling degree as a reference, the organic particles with the swelling degree not less than the average swelling degree are mainly distributed on a surface of the island regions, the inorganic particles and the organic particles with the swelling degree less than the average swelling degree are mainly distributed inside the island regions and on the planar regions.

20. The electrochemical device according to claim 18, wherein the porous substrate has a property that the porous substrate cannot be infiltrated with deionized water.
